(19) United States
(12) Patent Application Publication
(10) Pub. No.: US 2007/0137526 A1
(43) Pub. Date: Jun. 21, 2007

(54) Method for making high tint strength pigment compositions

(75) Inventors: Gregory Todd Hager, Edmond, OK (US); Michael L. Ashley, Oklahoma City, OK (US); Darci Pillars, Oklahoma City, OK (US)

Correspondence Address: William B. Miller, P. O. Box 268859, Oklahoma City, OK, 73126-8859, US

(73) Assignee: Tronox LLC

(21) Appl. No.: 11/312,846

(22) Filed: Dec. 19, 2005

(51) Int. Cl. C08K 3/32; C09C 1/36; C09C 1/00; C01G 23/047

(52) U.S. Cl. 106/436; 106/437; 106/438; 106/439; 106/442; 106/446; 423/610; 524/414

(57) ABSTRACT

The invention concerns a method for making a pigment composition comprising inorganic base particles and one or more inorganic spacer particles precipitated thereon, including the steps of forming an aqueous slurry of the inorganic base particles, if necessary, milling the aqueous slurry so that at least about 50% of the inorganic base particles are less than 0.5 microns in size, heating the slurry as needed to achieve and maintain a temperature of at least about 40 degrees Celsius, adjusting the pH of the slurry as needed to achieve and maintain a pH in the range of from 4 to 9, adding the inorganic spacer particles to the slurry while maintaining such temperature and pH conditions and with intensive mixing, and finally, recovering the pigment composition from the slurry.

### FIELD OF THE INVENTION

The present invention generally relates to inorganic pigment and especially titanium dioxide pigment compositions including so-called spacer materials, such as are incorporated in various polymers at desirably high pigment volume concentrations (PVCS) as whiteners, tinting agents and opacifiers. More particularly, but without limitation, the invention relates to methods for forming such compositions through the in-situ precipitation of the spacer materials in a slurry of the pigment, and to the resulting pigment compositions themselves.

### BACKGROUND AND SUMMARY OF THE INVENTION

Inorganic pigments, and especially titanium dioxide pigments, are often incorporated in various polymers as whiteners, tinting agents or opacifiers. Titanium dioxide pigments are especially useful for these purposes because they scatter light very efficiently due to their high refractive index. However, as the pigment volume concentration (PVC) increases in the polymer, the titanium dioxide particles can come close to or into contact with one another, in the process decreasing their collective light scattering efficiency. This “optical crowding” effect reduces scattering efficiency as measured by the hiding power or tinting strength of the titanium dioxide in the polymer.

As related in U.S. Pat. No. 5,886,069 to Bolt (herein after the '069 Patent), numerous attempts have been made to reduce this “optical crowding” effect. Thus, “extender particles” have been added to paint formulations to space the titanium dioxide (TiO2) particles and preserve scattering efficiency. Typical extender particles, or spacers, have a lower cost than the base TiO2 particles and can include silicas, aluminas, calcium carbonates, clays and other metal and mixed metal oxide particles. These extender particles are, however, difficult to disperse within the paint matrix to begin with, and typically are larger particles and/or aggregates that tend to decrease the effective TiO2 volume concentration and in turn decrease scattering efficiency of the TiO2. Prior to the '069 Patent, it had been recognized that high surface area silica could be precipitated onto the surface of the TiO2 particles, providing some improvement in scattering efficiency at a high PVC, but the precipitated silica unfortunately also imparts a tendency toward high oil absorption which can adversely impact film integrity.

Other methods have been suggested for improving the spacing of TiO2 particles in high PVC compositions, including the in situ formation of spacer particles on the base pigment, as exemplified by the aforementioned '069 Patent and U.S. Patent Application 2004/0202601 A1.

In the '069 Patent, substantially discrete inorganic particles of silica, calcium carbonate or mixtures thereof having diameters from 5 to 50 nanometers (nm) are dispersed on TiO2 pigment particles at less than 20 weight percent by total pigment weight, through mixing an aqueous slurry of the TiO2 particles with a colloidal suspension of the inorganic spacer particles under conditions such that both the TiO2 and the inorganic spacer particles are both above or below their respective isoelectric points. Pigments with spacer particles added thereon by this method are claimed to have high tinting strength and low oil absorption, which as noted above had been observed to adversely impact film integrity in regards to the in situ precipitation of high surface area silica.

In U.S. Patent Application 2004/0202601 A1 to Wen et al., which followed after the '069 Patent, precipitated calcium carbonate spacer particles are formed on the TiO2 in situ by bubbling carbon dioxide through a slurry containing lime and TiO2 pigment particles, using suitable surfactants to provide substantially spherical spacer particles ranging in size between about 0.1 and about 0.5 microns.

The present invention likewise provides methods for precipitating in situ, from a TiO2 slurry, one or more inorganic spacer materials preferably selected from among calcium carbonate and the oxides and hydroxides of silicon, aluminum, magnesium and zinc, though any of the inorganic spacer materials known to those skilled in the art may generally be used. By carefully controlling the conditions under which the spacer material or materials are precipitated, TiO2 pigments according to the present invention can comprise up to 25 percent by weight of the one or more inorganic spacer materials and exhibit more efficient light scattering and higher tinting strengths than pigments provided by prior art methods. Further, while the surface area and oil absorption of the inventive pigments are higher than for pigments produced according to the methods of the '069 Patent and the Wen et al. application, for example, film integrity is surprisingly not adversely impacted, as indicated by ink stain and scrub resistance tests.

### DETAILED DESCRIPTION OF THE PREFERRED EMBODIMENTS OF THE INVENTION

The present invention provides inorganic pigment compositions comprising inorganic base particles, preferably and especially being titanium dioxide particles, on which have been deposited one or more inorganic spacer materials. The spacer materials reduce optical crowding and provide improved tint strength in higher pigment volume concentration (PVC) uses of the inorganic pigment, including the deposited spacer materials in a polymer or combination of polymers and other conventional materials.

The preferred inorganic base pigment is a titanium dioxide in either of the two crystalline polymorphic forms produced commercially, whether the rutile form which can be produced by either the chloride or sulfate route or the anatase form produced principally by a sulfate process. Both of the chloride and sulfate processes are well known in the art and need not be described further. The titanium dioxide may include small quantities of impurities (i.e., iron), additives to the crystalline lattice (“burned-in” additives) and various surface coatings typically added to impart certain properties in finishing of a raw pigment generated in an oxidization or calcination step, all as conventionally known. The surface coatings in question, in the form of essentially continuous layers around the base pigment particle from an oxidization or calcination step, are to be distinguished from the present discrete inorganic spacer materials deposited in situ from a slurry of the finished TiO2.

The methods of the present invention start with an initial aqueous slurry of the inorganic base pigment to which the inorganic spacer materials are added. Such slurries can be made by methods and using apparatus known in the art, at various solids concentrations. Titanium dioxide slurries used for the in situ deposition of the inorganic spacer materials will typically have a TiO2 solids concentration of less than about 50%, preferably less than about 40% and more preferably less than about 35%. Typically, and unlike the Wen et al. application, no surfactant is necessary for the subsequent in situ deposition of the inorganic spacer materials on the TiO2 base pigment and none is used in forming the slurry initially.

The initial aqueous slurry is then milled as necessary to provide particles of which at least about 50% are less than 0.5 microns in size, though preferably at least about 80% and most preferably greater than about 90% are less than 0.5 microns in size. The pH of the slurry is adjusted to in the range of from 4 to 9, preferably being from 5 to 8 and most preferably being from 6 to 7, and in addition the slurry's temperature is preferably increased with continued intense mixing to at least about 40 degrees Celsius, more preferably to at least about 60 degrees Celsius and most preferably to at least about 80 degrees Celsius.

After permitting the slurry to digest for some time (for example, 15 minutes) at these conditions, the one or more inorganic spacer materials are incorporated in the slurry by in-situ precipitation, through addition in a mixing zone with mixing of an intensity such that the shear stress at all points in the mixing zone exceeds the yield stress of the slurry, while the pH of the slurry is kept within the range of from 4 to 9, preferably within 5 to 8 and most preferably within the optimum 6 to 7 range. Preferably the temperature of the slurry is kept during the addition at least above about 40 degrees Celsius, more preferably at about 60 degrees and above and most preferably at about 80 degrees Celsius and above. As will be seen from the examples below, tight control over slurry conditions during the precipitation is required to provide the completed pigment composition's desired high tint strength.

The inorganic spacer materials are preferably selected from among calcium carbonate and the oxides and hydroxides of silicon, aluminum, magnesium and zinc. Both the Wen et al. application and the '069 Patent independently describe a number of inorganic spacers which can be precipitated onto the TiO2 base pigment particles, and those skilled in the art will accordingly recognize that a number of inorganic spacer materials could be used if desired in addition to those listed herein. Sodium silicates and aluminates as well as aluminum sulfate are exemplified below, but any of the previously identified inorganic spacer particles should be useful provided they will effectively precipitate in situ under the conditions of the method outlined above. The inorganic spacer particles are preferably incorporated into the slurry at from about 7 to about 25 percent by weight, more preferably comprise from about 10 to about 20 percent by weight of the slurry and most preferably comprise from about 14 to about 18 percent by weight of the slurry.

In addition to the previously mentioned spacer materials, a final alumina post treatment may be carried out. It is well known to those skilled in the art that a final treatment with alumina can aid in dispersion as well as processability in manufacturing. This post alumina treatment can range from 0 to 6% on a TiO2 basis.

Thus, the general, preferred and most preferred conditions characterizing the methods of the present invention are as summarized in Table 1:

TABLE 1

| | General | Preferred | Most Preferred |
|---|---|---|---|
| pH | 4-9 | 5-8 | 6-7 |
| Temperature | >40 deg C. | >60 deg C. | >80 deg C. |
| Grind | >50% | >80% | >90% |
| Inorganic Loading | 7-25% | 10-20% | 14-18% |

The slurries produced according to the present inventive methods are generally avoided in pigment production as they exhibit increasingly high viscosities as the inorganic spacer materials are added, to the extent that the slurries cannot be readily mixed in a tank absent a deviation from the pH ranges given above and absent the addition of dispersants in the manner of the Wen et al. application. Apparent viscosities on the order of 10,000 centipoises and greater at 80 C as measured on a Brookefield Viscometer are typical following the addition of the inorganic spacer materials, and apparent viscosities in excess of about 25,000 cP may be expected in some cases. The sort of adjustments to the pH that would provide a desired reduction in viscosity, however, and the dispersants per Wen et al. have each been found to result in lower tint strengths in the context of the inventive processes, and so are themselves preferably avoided.

The slurries contemplated by the present invention, fortunately, may be characterized as Herschel-Bulkley fluids, exhibiting both a yield stress and shear thinning properties. The yield stress of the slurries produced by the inventive methods typically exceeds 10 Pa. By introducing a local zone of intensive mixing, sufficient mixing can be achieved in view of the shear-thinning character of the slurries to add in the one or more inorganic spacer materials and achieve the desired high tint strength pigment composition, after filtering, washing, drying and micronizing/high fluid energy milling. Those skilled in working with fluids of the character described will appreciate that this local zone of intensive mixing can be achieved in a number of ways, including but not being limited to through use of a high velocity recycle stream, through high shear planetary mixing and the like.

The present invention is illustrated more particularly by the following examples, which are given by way of example only and should not be taken as limiting of the present invention in any way, as our invention is defined in the claims which follow.

In the examples, the following test methods were used to evaluate the pigment properties:

i) Resistance was measured using a method in keeping with ASTM D-2448, except that in this case the resistance was measured without filtration to remove the pigment. The pH was measured in the same solution;

ii) Tint strength and tint tone were measured using a 60% PVC (pigment volume concentration) latex emulsion formulation tinted with carbon black. The PVC of the paint is above the CPVC (critical pigment volume concentration) for this system. A sample and a standard pigment were prepared in identical formulations. Both paints were then drawn down side by side on a Leneta card. The CIE L* and b* values of the dried paints were measured using an integrating sphere spectrophotometer and these values used to calculate the tint strength and tint tone.

Tint strength was calculated using the Kubelka Munk Equation where:

$$Tint Strength = \frac{{( \frac{K}{S} )}_{Standard}}{{( \frac{K}{S} )}_{Sample}} \times AssignedValue$$

where: K=Absorbance of carbon black pigment
   S=Scatter of titanium dioxide pigment

Tint Tone was calculated as follows:
TintTone=b*_{Sample}−b*_{S tan dard}+AssignedValue;

iii) Ink Stain was measured using an untinted drawdown of the same paint used in the tint strength test. The CIE L* of the dried film was measured using a integrating sphere spectrophotometer. A 1.0 mil drawdown of ink was applied to the paint film and allowed to penetrate for 2 minutes. The ink was then removed by vigorous rubbing with a naphtha based solvent and the CIE L* value again read.

The ink stain value was then calculated as follows:
InkStain=L*^{beforeInk}−L*_{afterink};

iv) Oil absorption was measured using a spatula rub-out method similar to ASTM D281-95. The only deviation from the ASTM method was the use of 5 grams of pigment in both the test and the calculations so that the result is still reported as grams of oil required to wet 100 grams of pigment;

v) Brightness and color were measured using a pressed pellet of dry pigment. In this test 5-6 grams of pigment were placed in a 29 mm ID cylindrical die and compressed to 2±0.2 metric tons for 30 seconds. The CIE L* and b* were measured using an integrating sphere spectrophotometer. The L* value was reported as brightness and b* value reported as color.

### EXAMPLE 1

A slurry was prepared consisting of 2600 grams of a base TiO2 pigment in 6900 milliliters of water, and then milled until 92% of the TiO2 particles were less than 0.5 microns in size. The slurry was heated to 90 degrees Celsius and the pH adjusted to 6 with 95% sulfuric acid. After digesting for 15 minutes, 1500 ml of sodium silicate (density of 1.254 g/cc, having a Na2O:SiO2 ratio of 0.31) and 290 ml of sodium aluminate (density of 1.307, having a Na2O:Al203 ratio of 0.97) were added incrementally over a period of an hour, while maintaining the pH of the slurry at 6 with the sulfuric acid. After the inorganic spacer materials had been added in this fashion, the slurry pH was adjusted downward to 5 and the slurry allowed to digest for an additional 15 minutes, at which time the slurry was filtered and the pigment solids washed to remove soluble salts. The filter cake was dried and micronized to yield a finished pigment composition according to the present invention.

Properties of the finished pigment composition are reported below in Table 2:

TABLE 2

| | |
|---|---|
| pH | 8.3 |
| Resistance | 8980 |
| Tint Strength | 116 |
| Tint Tone | −4.06 |
| Brightness | 96.7 |
| Color | 1.8 |
| Ink Stain | −6.6 |
| Oil Absorption | 50 |

### EXAMPLE 2

2220 ml of slurry was prepared with 960 grams of base titanium dioxide pigment particles in the balance of water, and this slurry was milled until 80% of the particles were less than 0.5 microns in size. The slurry was heated to 70 degrees Celsius and the pH adjusted to 6.5 with 95% concentrated sulfuric acid. After fifteen minutes, 430 ml of the same sodium silicate and 139 ml of the same sodium aluminate as used in Example 1 were added over the span of an hour, with the pH again being maintained throughout at 6.5 with additional sulfuric acid. The pH was then lowered to 4 and a further 70 ml of the sodium aluminate were added over the span of 15 minutes. The pH was again lowered to 5 with sulfuric acid and the slurry allowed to digest for 15 minutes. The resulting pigment composition was filtered, dried, micronized and evaluated as in Example 1, with the results shown in Table 3:

TABLE 3

| | |
|---|---|
| pH | 8.0 |
| Resistance | 4900 |
| Tint Strength | 113 |
| Tint Tone | −3.11 |
| Brightness | 96.7 |
| Color | 2.0 |
| Ink Stain | −6.8 |
| Oil Absorption | 48 |

### EXAMPLE 3

25 kg of base TiO2 were incorporated with water to make 73 liters of slurry, and the slurry was milled until 80% of the TiO2 particles were less than 0.5 microns in size. The slurry was heated to a temperature of 70 degrees Celsius and the pH lowered with 95% sulfuric acid to a value of 5.7. After fifteen minutes, 14.5 liters of the same sodium silicate and 2.7 liters of the same sodium aluminate were added over the space of an hour, while maintaining the pH in the range of 6-7 with sulfuric acid. After the hour had elapsed, the pH was adjusted to 6.4, followed by an additional 15 minute digestion period. The resulting pigment composition was filtered, washed, dried, micronized and evaluated. Results are reported in Table 4 as follows:

TABLE 4

| | |
|---|---|
| pH | 8.4 |
| Resistance | 3683 |
| Tint Strength | 115 |
| Tint Tone | −3.63 |
| Brightness | NA |
| Color | NA |
| Ink Stain | −6.7 |
| Oil Absorption | 51 |

What is claimed is:

1. A method for making a pigment composition, including the steps of:
a) forming an aqueous slurry of inorganic base particles;
b) if necessary, milling the aqueous slurry so that at least about 50% of the inorganic base particles are less than 0.5 microns in size;
c) adjusting the pH of the slurry as needed to achieve and maintain a pH in the range of from 4 to 9;
d) while maintaining such pH conditions, incorporating one or more inorganic spacer materials in the slurry by in situ precipitation, through addition of the inorganic spacer material or materials to the slurry in a mixing zone with mixing of an intensity such that the shear stress at all points in the mixing zone exceeds the yield stress of the slurry; and
e) then recovering the pigment composition from the slurry.

2. A method as defined in claim 1, further comprising the step of heating the slurry as needed to achieve and maintain a temperature of at least about 40 degrees Celsius prior to and during the step of incorporating the inorganic spacer material or materials in the slurry.

3. A method as defined in claim 1, wherein the inorganic base particles are of titanium dioxide and the inorganic spacer material or materials are incorporated in the slurry at from about 7 to about 25 percent by weight of the slurry.

4. A method as defined in claim 3, wherein the titanium dioxide slurry formed in step a) is characterized by a titanium dioxide solids concentration of less than about 50% by weight.

5. A method as defined in claim 4, wherein the titanium dioxide slurry has a titanium dioxide solids concentration of less than about 40% by weight, and the inorganic spacer material or materials are incorporated in the slurry at from about 10 to about 20 percent by weight of the slurry.

6. A method as defined in claim 5, wherein the titanium dioxide slurry has a titanium dioxide solids concentration of less than about 35% by weight, and the inorganic spacer material or materials are incorporated in the slurry at from about 14 to about 18 percent by weight of the slurry.

7. A method as defined in claim 2, wherein at least about 80% of the inorganic base particles in the slurry are less than 0.5 microns in size, the pH of the slurry in step c) that is achieved and maintained is from 5 to 8 and the temperature that is achieved and maintained is at least about 60 degrees Celsius.

8. A method as defined in claim 7, wherein the inorganic base particles are of titanium dioxide.

9. A method as defined in claim 8, wherein the initial titanium dioxide slurry has a titanium dioxide solids concentration of less than about 40% by weight, and the inorganic spacer material or materials are incorporated in the slurry at from about 10 to about 20 percent by weight of the slurry.

10. A method as defined in claim 2, wherein at least about 90% of the inorganic base particles in the slurry are less than 0.5 microns in size, the pH of the slurry in step d) that is achieved and maintained is from 6 to 7 and the temperature that is achieved and maintained is at least about 80 degrees Celsius.

11. A method as defined in claim 10, wherein the inorganic base particles are of titanium dioxide.

12. A method as defined in claim 11, wherein the initial titanium dioxide slurry has a titanium dioxide solids concentration of less than about 35% by weight, and the inorganic spacer material or materials are incorporated in the slurry at from about 14 to about 18 percent by weight of the slurry.

13. A method as defined in claim 1, wherein the intensity of mixing in the mixing zone is accomplished at least in part by means of a high velocity recycle of residual materials following recovery of the pigment composition.

14. A method as defined in claim 1, wherein the inorganic spacer material or materials are precipitated on the inorganic base particles without any added surfactant.

15. A method as defined in claim 14, wherein the intensity of mixing in the mixing zone is accomplished at least in part by means of a high velocity recycle of residual materials following recovery of the pigment composition.

16. A method as defined in claim 1, wherein the slurry of inorganic base particles to which the inorganic spacer material or materials are to be added is a Herschel-Bulkley fluid.

17. A method as defined in claim 16, wherein the slurry of inorganic base particles is characterized by a yield stress of in excess of 10 pascals.

18. A method as defined in claim 1, further comprising the step of depositing alumina particles on the pigment composition following the in situ precipitation of the inorganic spacer material or materials but prior to recovering the pigment composition from the slurry.
